(19) United States
(12) Patent Application Publication
(10) Pub. No.: US 2026/0073920 A1
(43) Pub. Date: Mar. 12, 2026

(54) LONG-FORM AUDIO-TEXT ALIGNMENT

(71) Applicant: Google LLC, Mountain View, CA (US)

(72) Inventors: Qingyun Dou, New York City, NY (US); Zeyu Liu, Jersey City, NJ (US); Parisa Haghani, Jersey City, NJ (US)

(21) Appl. No.: 18/882,423

(22) Filed: Sep. 11, 2024

(51) Int. Cl. G10L 15/26; G10L 15/04; G10L 25/78

(52) U.S. Cl. CPC G10L 15/26; G10L 15/04; G10L 25/78

(57) ABSTRACT

Methods, systems, and apparatus, including computer programs encoded on computer storage media, for performing long-form audio-text alignment. One of the methods includes: receiving audio data and a ground-truth text transcript of the audio data to be aligned with the audio data; dividing the audio data into a plurality of audio segments; each of the plurality of audio segments: processing the audio segment using an automatic speech recognition (ASR) model to generate a machine transcript of the audio segment; identifying, from the ground-truth text transcript, a matching portion of the ground-truth text transcript that matches the machine transcript of the audio segment; and generating audio-text alignment data that defines a correspondence between audio in the audio segment and text in the matching portion.

### BACKGROUND

This specification relates to aligning portions of audio data to a transcript of the audio data.

In some implementations, audio data can be aligned to a transcript based on a forced alignment technique, which takes an orthographic transcription of an audio file and generates a time-aligned version using a pronunciation dictionary to look up phones for words.

In some implementations, neural networks can be used to align audio data to a transcript. For example, a neural network can include an acoustic component that identifies which sounds occur in speech, and a language component that determines what words or sequences of words are most likely given the sounds identified by the acoustic component.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

However, long audio can be difficult to be aligned to its associated transcript due to the high computational complexity of the existing techniques for aligning audio data to transcripts. For example, some existing forced alignment algorithms have quadratic complexity, i.e., the memory or processing power or both consumption increases as square of the length of the audio increases. Such quadratic complexity may make it computationally intensive to align long audio data to its transcript. Additionally, using existing techniques to align long audio to its transcript may result in high error rates (e.g., in terms of word error rates (WER)).

### SUMMARY

This specification describes a system implemented as computer programs on one or more computers in one or more locations that receives audio data and a ground-truth text transcript of the audio data and generates audio-text alignment data that defines a correspondence between the audio in the audio data and the text in the ground-truth text transcript.

Particular embodiments of the subject matter described in this specification can be implemented so as to realize one or more of the following advantages.

The audio-text alignment system described in the specification can perform long-form audio-text alignment to align audio data of a long audio session to a corresponding ground-truth text transcript by using an automatic speech recognition (ASR) model. For example, the long audio session could be over an hour long, over two hours long, and so on. The audio-text alignment system can accurately align the audio data to the corresponding ground-truth text transcript even when the machine transcripts of audio segments generated by the ASR model based on the audio data have errors or other discrepancies compared to the ground-truth text transcript.

Moreover, the described audio-text alignment system is memory efficient and also time efficient. By not having to compare every character or word in the machine transcripts to the characters or words in the corresponding ground-truth text transcript, and instead by comparing groups of text having a fixed length, the described system achieves linear time and memory complexity. The described system can therefore align the audio data to the ground-truth text transcript more quickly and with reduced processor usage and reduced memory consumption, compared to some existing audio-text alignment systems that perform whole sequence matching.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example audio-text alignment system.

FIG. 2 is an example illustration of operations performed by an audio-text alignment system to align audio data to a text transcript.

FIG. 3 is a flow diagram of an example process for aligning audio data to a ground-truth text transcript.

FIG. 4 is a flow diagram of sub-steps of one of the steps of the process of FIG. 3.

Like reference numbers and designations in the various drawings indicate like elements.

### DETAILED DESCRIPTION

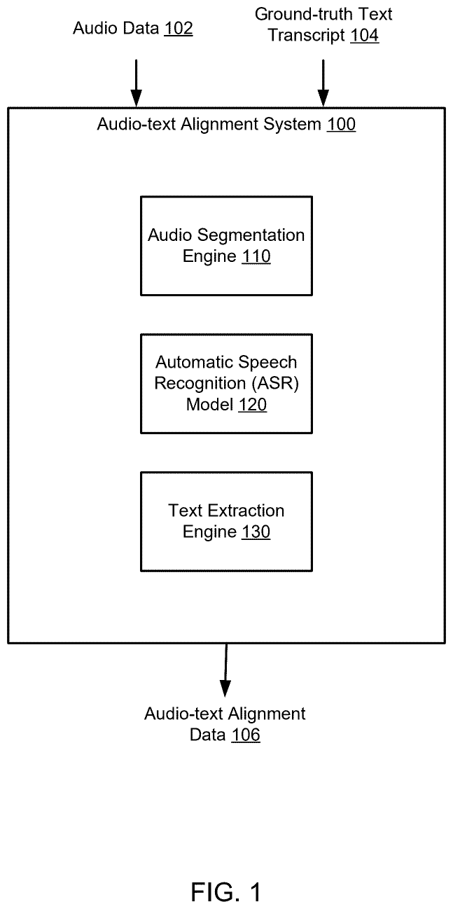

FIG. 1 shows an example audio-text alignment system 100. The audio-text alignment system 100 is an example of a system implemented as computer programs on one or more computers in one or more locations, in which the systems, components, and techniques described below can be implemented.

The audio-text alignment system 100 is a system that receives audio data 102 and a ground-truth text transcript 104 of the audio data, and generates audio-text alignment data 106. The audio-text alignment data 106 defines a correspondence between the audio included in the audio data 102 and the text included in the ground-truth text transcript 104.

The correspondence can include a temporal correspondence. For each text component, e.g., word, phrase, or character, in the ground-truth text transcript 104, the audio-text alignment data 106 defines or otherwise specifies a timing window within the audio data 102 that an audio of the text component occurs, e.g., is spoken by a speaker.

The audio-text alignment system 100 can receive the audio data 102 and the ground-truth text transcript 104 in any of a variety of ways.

For example, the audio-text alignment system 100 can receive the audio data 102 and the ground-truth text transcript 104 as one or more uploads from a user of the system over a data communication network, e.g., using an application programming interface (API) made available by the system. As another example, the audio-text alignment system 100 can receive an input from a user specifying which data that is already maintained by the system 100 or another system that is accessible by the system 100 should be used as the audio data 102 and the ground-truth text transcript 104.

The audio data 102 includes audio that represents speech, i.e., utterances spoken by one or more speakers. The audio included in the audio data 102 can be represented in any of a variety of formats, e.g., as waveforms (e.g., raw audio waveforms, compressed/companded waveforms, and so on), as frequency spectrums, or as spectrograms (including mel spectrograms).

In some cases, the audio data 102 can be long-form audio data that includes audio of a long audio session, which could be, for example, over an hour long, over two hours long, and so on. For example, the audio data 102 can include speech of long speech sessions, e.g., a presentation, a newscast, a seminar, or a conference. As another example, the audio data 102 can include speech of other long audio sessions, e.g., an audio track for a movie or video, a song, an audio book, or other audio work.

The ground-truth text transcript 104 is a textual representation of the speech. For example, the ground-truth text transcript 104 can include each word in the speech represented by the audio included in the audio data 102 and in the order in which the words were spoken. In some implementations, the ground-truth text transcript 104 can be generated by a verified human transcriber or a verified, automated speech transcription system.

The ground-truth text transcript 104 may lack the information about the correspondences between the audio in the audio data 102 and the text in the ground-truth text transcript 104 the audio data 112. For example, the ground-truth text transcript 104 may provide little or no time information about when a particular word in the ground-truth text transcript 104 was spoken in the speech represented by the audio included in the audio data 102.

On the other hand, the audio-text alignment data 106 that is generated by the audio-text alignment system 100 aligns the audio data 102 with the ground-truth text transcript 104, i.e., the audio-text alignment data 106 defines a correspondence between the audio in the audio data 102 and the text in the ground-truth text transcript 104.

The correspondence can be a temporal correspondence, and can be defined in any of a variety of ways.

Suppose the audio data 102 includes audio that represents an utterance “the quick brown fox jumped over the lazy dog,” and the ground-truth text transcript 104 is “the quick brown fox jumped over the lazy dog. ” As an example, the audio-text alignment data 106 can identify that a first audio segment of the audio (e.g., between 00:01:10 and 00:01:12) in the audio data 102 maps to a first phrase “the quick brown fox” in the ground-truth text transcript 104, and also identify that a second audio segment of the audio (e.g., between 00:01:12 and 00:01:13) in the audio data 102 maps to a second phrase “jumped over”in the ground-truth text transcript 104.

As another example, the audio-text alignment data 106 can indicate a certain timing window (e.g., a certain point in time or a certain time range) within which a corresponding audio of each word or phrase in the ground-truth text transcript 104 occurs in the audio data 102. The timing window can be either definite, e.g., the audio of “the quick brown fox” occurs at 00:01:10 in the audio data 102, the audio of “jumped over” occurs at 00:01:12 in the audio data 102, and so on, or relative, e.g., the audio of “jumped over” occurs at 2.00 seconds after the audio of “the quick brown fox” in the audio data 102.

To generate the audio-text alignment data 106, the audio-text alignment system 100 uses an audio segmentation engine 130, an automatic speech recognition (ASR) model 120, and a text extraction engine 130.

Upon receiving the audio data 102, the audio segmentation engine 130 divides or partitions the audio included in the audio data 102 into a plurality of audio segments. There are many ways in which the audio included in the audio data 102 can be divided.

In some implementations, the plurality of audio segments can be nonoverlapping. For example, a given audio frame (a fixed interval of the audio) may be included within only one audio segment of the plurality of audio segments.

In some implementations, the plurality of audio segments can each have about equal length. For example, the audio can be divided into audio segments based at least in part on a fixed segment length. That is, the audio can be divided into a plurality of audio segments, where each audio segment has a fixed duration or length.

In other implementations, the plurality of audio segments can have different lengths. For example, the audio can be divided into audio segments of varying lengths. For example, for every frame (after the first frame) in the audio, the audio segmentation engine 130 samples a value for a binary decision variable that defines whether or not the frame should be included in the same audio segment as an immediately preceding frame.

As another example, an audio can be divided into audio segments based on voice activity detection (VAD).

Voice activity detection (VAD), also sometimes known as endpointing, refers to classifying each frame of an audio as either speech or silence (non-speech). In this example, an audio can be divided into two audio segments as soon as a VAD system detects an interval of silence that follows a speech. In some implementations the VAD system can implement an audio classification neural network, e.g., a recurrent neural network or an attention neural network, that processes each frame and classifies the frame as either speech or silence.

For example, the neural network can be one of the neural networks mentioned in Hughes, Thad, and Keir Mierle. “Recurrent neural networks for voice activity detection. ” 2013 IEEE International Conference on Acoustics, Speech and Signal Processing. IEEE, 2013, and Sehgal, Abhishek, and Nasser Kehtarnavaz. “A convolutional neural network smartphone app for real-time voice activity detection. ” IEEE access 6 (2018): 9017-9026.

The automatic speech recognition (ASR) model 120 transcribes the speech represented by the audio included in the audio data 102, i.e., transcribes the utterances spoken by the one or more speakers. Specifically, for each of the plurality of audio segments, the ASR model 120 processes the audio segment to generate a predicted, machine transcript of the audio included in the audio segment.

In some implementations, the ASR model 120 can implement a speech recognition neural network, e.g., a recurrent neural network or an attention neural network, or another machine learning model, which has been trained on training data including audio data with corresponding transcriptions. In some implementations, the ASR model 120 can implement a statistical speech recognition model, e.g., a Hidden Markov model (HMM) or a dynamic time warping (DTW) model.

The text extraction engine 130 executes a text matching algorithm to identify different groups of text from the ground-truth text transcript 104 based on the machine transcripts generated by the ASR model 120. Specifically, for each of the plurality of audio segments, the text extraction engine 130 identifies, from the ground-truth text transcript 104, a matching portion of the ground-truth text transcript 104 that matches the machine transcript of the audio segment that has been generated by the ASR model 120.

For each of the plurality of audio segments, after having identified the matching portion of the ground-truth text transcript 104, the audio-text alignment system 100 generates audio-text alignment data for the audio segment that defines a correspondence between the audio included in the audio segment and the text included in the matching portion. By combining the audio-text alignment data generated for each of the plurality of audio segments, the audio-text alignment system 100 can generate the audio-text alignment data 106 for the audio data 102 and the ground-truth text transcript 104 of the audio data.

As noted above, the audio-text alignment data 106 defines a correspondence, e.g., a temporal correspondence, between the audio in the audio data 102 and the text in the ground-truth text transcript 104. For each text component, e.g., word, phrase, or character, in the ground-truth text transcript 104, the audio-text alignment data 106 defines or otherwise specifies a timing window within the audio data 102 that an audio of the text component occurs, e.g., is spoken by a speaker.

The audio-text alignment data 106 can then be used in any of a variety of ways.

For example, the audio-text alignment system 100 can provide the audio-text alignment data 106 for presentation to a user, e.g., the user that uploaded the audio data 102 and the ground-truth text transcript 104 of the audio data, on a display device.

As another example, the audio-text alignment system 100 can provide the audio-text alignment data 106 to another component in the system, or another system, for further processing.

As yet another example, the audio-text alignment system 100 can store the audio-text alignment data 106 in a data repository for some future purpose.

As a particular example, the audio-text alignment system 100 can output the audio-text alignment data 106 to a timed text generation system—and the timed text generation system can use the audio-text alignment data 106 to generate timed text for the audio included in the audio data 102.

The timed text can then be provided for display in conjunction with audio and is “timed” so that certain text appears in association with certain portions of the audio. For example, the timed text can be displayed as captions or subtitles when the audio is being played back to a user, e.g., jointly with a corresponding video or other corresponding content or only the audio track.

Timed text can serve a number of purposes. First, timed text can make the speech understandable to the hearing impaired. Second, timed text can make the audio understandable in environments where audio is unavailable or not permitted. Third, timed text can provide commentary to audio with educational or entertainment value. Fourth, timed text can translate audio for those who do not understand the language of the speech.

As another particular example, the audio-text alignment system 100 can output the audio-text alignment data 106 to a training system—and the training system can use the audio-text alignment data 106 to generate training data for a neural network and then use the training data to train the neural network by learning the trained values of the parameters of the neural network, e.g., based on optimizing an objective function computed using the training data. For example, the training data can be in the form of audio-text pairs. Each audio-text pair includes an audio sample that is paired with a text sequence that is a transcript of the audio sample.

In this particular example, the neural network can have any of a variety of architectures, and can be trained to perform any of a variety of tasks.

For example, the neural network can be a speech-to-text neural network, e.g., one of the speech-to-text neural networks mentioned in Prabhavalkar, Rohit, et al. “End-to-end speech recognition: A survey. ” IEEE/ACM Transactions on Audio, Speech, and Language Processing (2023), which can be configured through the training to receive a network input that includes audio data that includes speech and to process the network input to generate a network output that includes a predicted text transcript of the speech.

As another example, the neural network can be a text-to-speech neural network, e.g., one of the text-to-speech neural networks mentioned in Wang, Yuxuan, et al. “Tacotron: Towards end-to-end speech synthesis. ” arXiv preprint arXiv: 1703.10135 (2017) and Ren, Yi, et al. “Fastspeech 2: Fast and high-quality end-to-end text to speech. ” arXiv preprint arXiv: 2006.04558 (2020), which can be configured through the training to receive a network input that includes text and to process the network input to generate a network output that includes a synthesized speech utterance of the text.

As another example, the neural network can be a multimodal neural network that can process both textual and audio data to generate an output for a multimodal machine learning task, e.g., one of the multimodal neural networks mentioned in Gemini Team, et al. Gemini: a family of highly capable multimodal models. arXiv preprint arXiv: 2312.11805 (2023).

For example, the multimodal machine learning task can be a text-based audio retrieval task or an audio-based text retrieval task. As another example, the multimodal machine learning task can be a real-time audio-text alignment task. As another example, the multimodal machine learning task can be a missing audio prediction task that requires the neural network to predict a missing portion of an audio sample based on processing a text sequence that is a complete transcript of the audio sample.

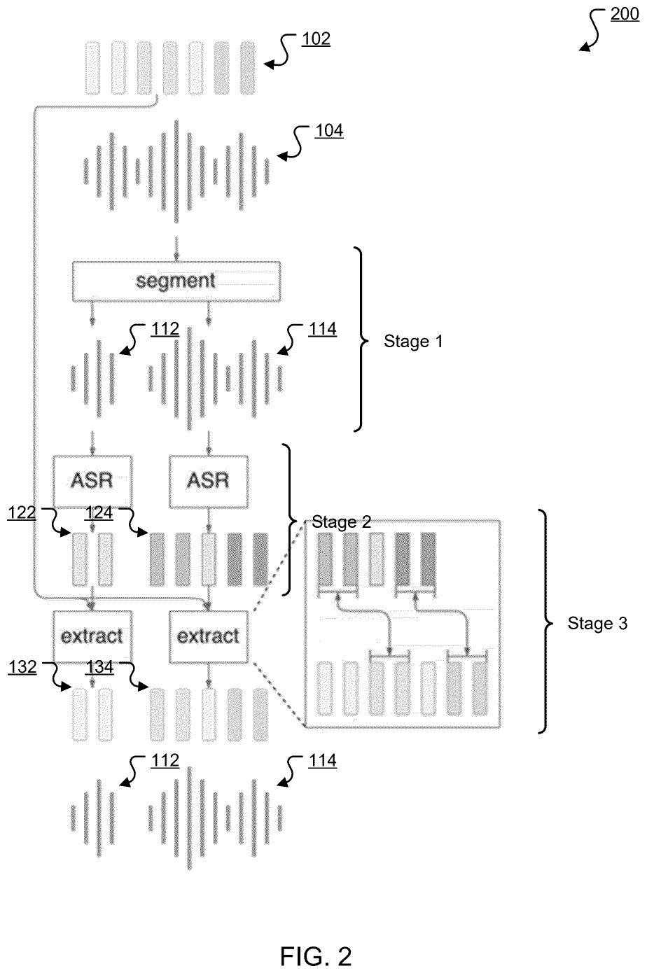

FIG. 2 is an example illustration 200 of operations performed by an audio-text alignment system 100 to align audio data 102 to a ground-truth text transcript 104 of the audio data. The operations can be grouped into stage (1), stage (2), and stage (3) which can be performed in the order indicated in FIG. 2.

During stage (1), the audio-text alignment system 100 divides or partitions the audio included in the audio data 102 into a plurality of audio segments. The plurality of audio segments can have equal or different lengths. For example, FIG. 2 illustrates that the audio included in the audio data 102 is divided into a first audio segment 112 and a second audio segment 114.

During stage (2), the audio-text alignment system 100 processes each of the plurality of audio segments using an automatic speech recognition (ASR) model to generate a machine transcript of the audio segment. For example, FIG. 2 illustrates that a first machine transcript 122 is generated for the first audio segment 112 and a second machine transcript 124 is generated for the second audio segment 114. The ASR model need not make use of the ground-truth text transcript 104 when generating the machine transcripts of the plurality of audio segments.

In some implementations, the audio-text alignment system 100 parallelizes the operations performed on each audio segment during stage (2), e.g., such that the first machine transcript 122 is generated in parallel with the second machine transcript 124. Parallelized processing can decrease the overall time needed for generating the machine transcripts of the plurality of audio segments.

For example, the audio-text alignment system 100 can do this by running an instance of the ASR model on each set of machines in multiple different sets of machines, or running an instance of the ASR model on each thread or core in multiple different threads or cores of one machine, and then processing a respective audio segment using each instance of the ASR model in parallel with other instances of the ASR model.

During stage (3), the audio-text alignment system 100 identifies, from the ground-truth text transcript, a matching portion of the ground-truth text transcript 102 that matches the machine transcript of the audio segment. For example, FIG. 2 illustrates that a first matching portion 132 of the ground-truth text transcript 102 is identified for the first machine transcript 122, and a second matching portion 134 of the ground-truth text transcript 102 is identified for the second machine transcript 124.

In effect, in the example of FIG. 2, the audio-text alignment system 100 identifies the first matching portion 132 as a textual representation of the audio included in the first audio segment 112, and identifies the second matching portion 134 as a textual representation of the audio included in the second audio segment 114.

There are many ways in which the audio-text alignment system 100 can identify the matching portion of the ground-truth text transcript 102 for each audio segment.

In some implementations, for each of the plurality of audio segments, to identify the matching portion of the ground-truth text transcript 102, the audio-text alignment system 100 executes a text matching algorithm based on the machine transcripts that have been generated by using the ASR model during stage (2).

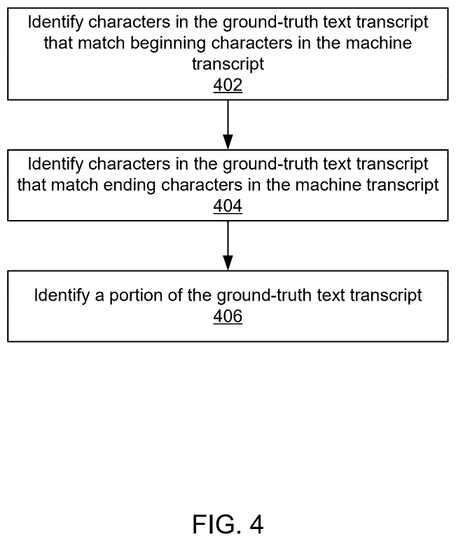

As will be explained in more detail below with reference to FIG. 4, the text matching algorithm uses an edit distance between the text included in the machine transcripts and the text included in the ground-truth text transcript 102 to find the matching portion of the ground-truth text transcript 102 for a given audio segment.

In some other implementations, the audio-text alignment system 100 can use a different algorithm, e.g., a string searching algorithm or an approximate string matching algorithm, to identify the matching portion of the ground-truth text transcript 102 for each of the plurality of audio segments.

In yet other implementations, the audio-text alignment system 100 can use machine learning techniques, e.g., a machine learning model (e.g., a neural network) configured to perform text matching tasks, to identify the matching portion of the ground-truth text transcript 102 for each of the plurality of audio segments.

In some implementations, the audio-text alignment system 100 similarly parallelizes the operations performed on each audio segment during stage (3), e.g., such that the first matching portion 132 is identified for the first audio segment 112 in parallel with the second matching portion 134 being identified for the second audio segment 114. Parallelized processing can decrease the overall time needed for identifying the matching portions of the ground-truth text transcript 102 for the plurality of audio segments.

Having performed these operations, the audio-text alignment system 100 can proceed to generate audio-text alignment data.

For example, the audio-text alignment system 100 can generate audio-text alignment data that defines a mapping between each of the plurality of audio segments and the corresponding, matching portion of the ground-truth text transcript.

For example, in the example of FIG. 2, the audio-text alignment data can define that the first audio segment 112 maps to the first matching portion 132 of the ground-truth text transcript 102, as well as that the second audio segment 114 maps to the second matching portion 134 of the ground-truth text transcript 102.

As another example, the audio-text alignment system 100 can generate audio-text alignment data that indicates a timing window (e.g., a certain point in time or a certain time range) within which a corresponding audio of each of one or more words or phrases in the ground-truth text transcript 104 occurs in the audio data 102.

For example, in the example of FIG. 2, the audio-text alignment data can indicate that the corresponding audio of the phrase included in the first matching portion 132 of the ground-truth text transcript 102 occurs during a time range of the first audio segment 112, as well as that the corresponding audio of the phrase included in the second matching portion 134 of the ground-truth text transcript 102 occurs during a time range of the second audio segment 114.

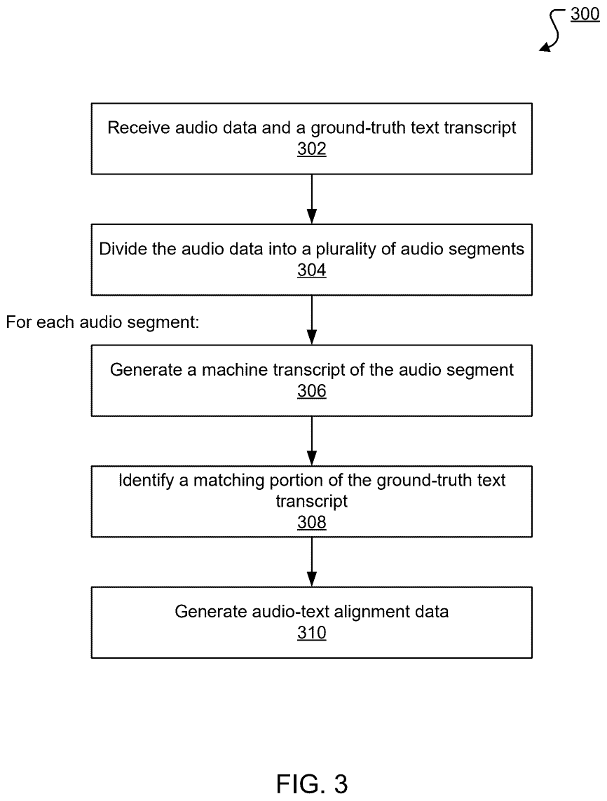

FIG. 3 is a flow diagram of an example process 300 for aligning audio data to a ground-truth text transcript. For convenience, the process 300 will be described as being performed by a system of one or more computers located in one or more locations. For example, an audio-text alignment system, e.g., the audio-text alignment system 100 depicted in FIG. 1, appropriately programmed in accordance with this specification, can perform the process 300.

The system receives audio data and a ground-truth text transcript of the audio data to be aligned with the audio data (step 302). The audio data includes audio that represents speech, i.e., utterances spoken by one or more speakers. The ground-truth text transcript is a textual representation of the speech. For example, the ground-truth text transcript can include each word in the speech represented by the audio included in the audio data and in the order in which the words were spoken.

The system does not receive any data defining the correspondence between the audio included in the audio data and the text included in the ground-truth text transcript. For example, the ground-truth text transcript does not have any timestamp information associated with the text that may be used to map different portions of text to different timing windows in the audio data 102.

The system divides or partitions the audio included in the audio data into a plurality of audio segments (step 304). The plurality of audio segments can have equal or different lengths. There are many ways in which the audio included in the audio data can be divided. For example, the system can randomly divide the audio into audio segments, or use voice activity detection (VAD) to divide the audio into audio segments based on intervals of silence that have been detected between speech in the audio.

The system performs following steps 306-310 for each of the plurality of audio segments.

The system processes the audio segment using an automatic speech recognition (ASR) model to generate a predicted, machine transcript of the audio segment (step 306). For example, the ASR model can implement a speech recognition neural network or a statistical speech recognition model.

The system identifies, from the ground-truth text transcript, a matching portion of the ground-truth text transcript that matches the machine transcript of the audio segment (step 308).

In some implementations, the system can do this by executing a text matching algorithm that uses an edit distance. The text matching algorithm is described in more detail below with reference to FIG. 4, which is a flow diagram of sub-steps 402-406 of step 308 of the process of FIG. 3.

In some other implementations, the system can do this by using a different algorithm, e.g., a string searching algorithm or an approximate string matching algorithm, or by using machine learning techniques (e.g., a text matching neural network).

The system identifies N characters in the ground-truth text transcript that match the N beginning characters in the machine transcript of the audio segment (step 402). N can be any positive integer which is, in some implementations, no greater than M/2, where M is the total number of characters in the ground-truth text transcript.

To do this, the system determines a respective edit distance between (i) the N beginning characters in the machine transcript of the audio segment and (ii) each of multiple groups of adjacent characters in the ground-truth text transcript.

Each group of adjacent characters has a fixed length, i.e., includes the same fixed number of (N) adjacent characters in the ground-truth text transcript. Each group of adjacent characters has at least one different character than another group of adjacent characters. For example, the system can apply a sliding window to the ground-truth text transcript to extract each possible group of adjacent characters having a predetermined fixed length from the ground-truth text transcript.

The edit distance can be one of: a Hamming distance, a Levenshtein distance, a Damerau-Levenshtein distance, or a Jaro-Winkler distance, to name just a few.

The system then uses the respective edit distances to identify which one of the multiple groups of adjacent characters should be used as the N characters in the ground-truth text transcript that match the N beginning characters in the machine transcript of the audio segment. In the examples mentioned above, a smaller edit distance indicates a greater similarity.

Thus, for example, the system can use the group of adjacent characters that has the smallest edit distance among the multiple groups of adjacent characters as the N characters in the ground-truth text transcript that match the N beginning characters in the machine transcript of the audio segment.

The system identifies N characters in the ground-truth text transcript that match the N ending characters in the machine transcript of the audio segment, where N can be any positive integer (step 404).

To do this, the system determines a respective edit distance between (i) the N ending characters in the machine transcript of the audio segment and (ii) each of multiple groups of adjacent characters in the ground-truth text transcript, and then uses the respective edit distances to identify which one of the multiple groups of adjacent characters should be used as the N characters in the ground-truth text transcript that match the N ending characters in the machine transcript of the audio segment. The edit distance used in step 404 can be the same or different edit distance than the edit distance used in step 402.

The system identifies, as the matching portion of the ground-truth text transcript, a portion of the ground-truth text transcript (step 406). In general, the matching portion of the ground-truth text transcript is longer, i.e., includes more characters, than the characters in the ground-truth text transcript that have been identified in steps 402 and 404.

In particular, the portion of the ground-truth text transcript includes (i) the N characters in the ground-truth text transcript that match the N beginning characters of the machine transcript of the audio segment, (ii) the N characters in the ground-truth text transcript that match the N ending characters of the machine transcript of the audio segment, and (iii) any characters in between (i) and (ii) in the ground-truth text transcript.

Suppose, for example, the ground-truth text transcript includes the phrase: “the quick brown fox jumped over the slow gray fox,” the machine transcript of an audio segment includes the phrase: “quick black fox,” and N =3, then “qui” can be identified as the N characters in the ground-truth text transcript that match the N beginning characters in the machine transcript of the audio segment, and “fox” can be identified as the N characters in the ground-truth text transcript that match the N ending characters in the machine transcript of the audio segment. Correspondingly, in this example, “quick brown fox” can be identified as the matching portion of the ground-truth text transcript that matches the machine transcript of the audio segment.

Identifying the matching portion of the ground-truth text transcript based on matching the beginning and ending characters in the machine transcript of the audio segment, instead of attempting to match all of the characters included in the machine transcript, has a number of advantages.

First, doing so can reduce the time and space complexity of the text matching algorithm from O(ML\hat{ }2) to O(M), where L is the length of, i.e., the number of characters in, a machine transcript of an audio segment. In other words, the system can align the audio data to the ground-truth text transcript more quickly and with reduced processor usage and reduced memory consumption compared to some existing audio-text alignment systems that perform whole sequence matching of the machine transcripts (in which case the time and space complexity would be O(ML\hat{ }2)).

Second, doing so can improve the accuracy of the matching by mitigating the impact of ASR errors that might occur between the N beginning and N ending characters in the machine transcript. In the example above, despite that the ASR model mistakenly transcribes the audio of “brown” as “black,” the text matching algorithm is still able to correctly identify the matching portion of the ground-truth text transcript.

While this example discusses that the edit distance is computed at character level, this is not required. That is, the system can alternatively compute the edit distance at a different level, e.g., a subword level, a word level, a phrase level, and so on.

As an example, the system can identify the matching portion of the ground-truth text transcript that matches the machine transcript of the audio segment based on executing the text matching algorithm at a word level.

That is, for a given audio augment, the system can identify N words in the ground-truth text transcript that match N beginning words in the machine transcript of the given audio segment; identify N words in the ground-truth text transcript that match N ending words in the machine transcript of the given audio segment; and identify, as the matching portion of the ground-truth text transcript, a portion of the ground-truth text transcript that includes (i) the N words in the ground-truth text transcript that match the N beginning words of the machine transcript of the given audio segment, (ii) the N words in the ground-truth text transcript that match the N ending words of the machine transcript of the given audio segment, and (iii) any words in between (i) and (ii) in the ground-truth text transcript.

The system generates audio-text alignment data for the audio segment (step 310). The audio-text alignment data defines a correspondence between the audio in the audio segment and text in the matching portion of the ground-truth text transcript.

In some implementations, the system can generate audio-text alignment data by associating the audio segment with the matching portion of the ground-truth text transcript. In these implementations, the correspondence can be a segment-level temporal correspondence. That is, for each phrase in the ground-truth text transcript, where each phrase includes multiple words, the audio-text alignment data can define or otherwise specify a timing window within the audio data that an audio of the phrase occurs, e.g., is spoken by a speaker.

For example, the system can generate mapping data that associates the audio segment with the matching portion of the ground-truth text transcript. As another example, the system can generate timestamp data for the matching portion of the ground-truth text transcript. The timestamp data identifies a corresponding timing window within the audio that contains the audio segment.

In some other implementations, the system can generate audio-text alignment data by further processing the audio segment and the matching portion of the ground-truth text transcript. In these implementations, the correspondence can be a lower-level temporal correspondence than segment-level temporal correspondence mentioned above, e.g., it can be a word-level or character-level temporal correspondence. That is, for each word or character in the ground-truth text transcript, the audio-text alignment data can define or otherwise specify a timing window within the audio data that an audio of the word or character occurs, e.g., is spoken by a speaker.

For example, the system can further process the audio segment and the matching portion of the ground-truth text transcript using a forced aligner to generate data that defines a word-level or character-level temporal correspondence between the audio segment and the matching portion of the ground-truth text transcript. Examples of the forced aligner that can be used by the system are described in McAuliffe, Michael, et al. “Montreal forced aligner: Trainable text-speech alignment using kaldi. ” Interspeech. Vol. 2017. 2017, and Gorman, Kyle, Jonathan Howell, and Michael Wagner. “Prosodylab-aligner: A tool for forced alignment of laboratory speech. ” Canadian acoustics 39.3 (2011): 192-193.

Optionally, in some implementations, after having performed the steps 306-310 for each of the plurality of audio segments, the system then combines the audio-text alignment data for each audio segment to generate combined audio-text alignment data for the entire audio included in the audio data received at step 302. For example, the system can concatenate the mapping data to generate concatenated mapping data, or consolidate the timestamp data to generate consolidated timestamp data.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method comprising:
receiving audio data and a ground-truth text transcript of the audio data to be aligned with the audio data;
   dividing the audio data into a plurality of audio segments;
   for each of the plurality of audio segments:
      processing the audio segment using an automatic speech recognition (ASR) model to generate a machine transcript of the audio segment;
      identifying, from the ground-truth text transcript, a matching portion of the ground-truth text transcript that matches the machine transcript of the audio segment; and
      generating audio-text alignment data that defines a correspondence between audio in the audio segment and text in the matching portion.

Embodiment 2 is the method of embodiment 1, the plurality of audio segments have a same length.

Embodiment 3 is the method of embodiment 1, wherein the plurality of audio segments have different lengths.

Embodiment 4 is the method of any one of embodiments 1-3, wherein dividing the audio data into the plurality of audio segments comprises using a voice activity detection (VAD) method to divide the audio data.

Embodiment 5 is the method of any one of embodiments 1-5, wherein identifying the matching portion of the ground-truth text transcript that matches the machine transcript of the audio segment comprises:
identifying one or more characters in the ground-truth text transcript that match one or more beginning characters in the machine transcript of the audio segment;
identifying one or more characters in the ground-truth text transcript that match one or more ending characters in the machine transcript of the audio segment; and
identifying, as the matching portion of the ground-truth text transcript, a portion of the ground-truth text transcript that includes (i) the one or more characters in the ground-truth text transcript that match the one or more beginning characters of the machine transcript of the audio segment, (ii) the one or more characters in the ground-truth text transcript that match the one or more ending characters of the machine transcript of the audio segment, and (iii) any characters in between (i) and (ii) in the ground-truth text transcript.

Embodiment 6 is the method of embodiment 5, wherein identifying the one or more characters in the ground-truth text transcript that match the one or more beginning characters in the machine transcript of the audio segment comprises:
identifying the one or more characters in the ground-truth text transcript based on computing an edit distance between (i) characters in the ground-truth text transcript and (ii) the one or more beginning characters in in the machine transcript of the audio segment.

Embodiment 7 is the method of embodiment 5, wherein identifying the one or more characters in the ground-truth text transcript that match the one or more ending characters in the machine transcript of the audio segment comprises:
identifying the one or more characters in the ground-truth text transcript based on computing an edit distance between (i) characters in the ground-truth text transcript and (ii) the one or more ending characters in in the machine transcript of the audio segment.

Embodiment 8 is the method of any one of embodiments 6-7, wherein the edit distance comprises a Levenshtein distance.

Embodiment 9 is the method of any one of embodiments 1-8, further comprising
combining the audio-text alignment data for each of the plurality of audio segments to generate combined audio-text alignment data.

Embodiment 10 is the method of embodiment 9, further comprising using the combined audio-text alignment data to generate audio-text training data for training a multimodal neural network.

Embodiment 11 is the method of embodiment 9, wherein further comprising using the combined audio-text alignment data to generate timed text for the audio data.

Embodiment 12 is the method of any one of embodiments 1-11, wherein the audio data comprises audio of a long audio session.

Embodiment 13 is a system comprising: one or more computers and one or more storage devices storing instructions that are operable, when executed by the one or more computers, to cause the one or more computers to perform the method of any one of embodiments 1 to 12.

Embodiment 14 is a computer storage medium encoded with a computer program, the program comprising instructions that are operable, when executed by data processing apparatus, to cause the data processing apparatus to perform the method of any one of embodiments 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving audio data and a ground-truth text transcript of the audio data to be aligned with the audio data;
dividing the audio data into a plurality of audio segments;
for each of the plurality of audio segments:
processing the audio segment using an automatic speech recognition (ASR) model to generate a machine transcript of the audio segment;
identifying, from the ground-truth text transcript, a matching portion of the ground-truth text transcript that matches the machine transcript of the audio segment; and
generating audio-text alignment data that defines a correspondence between audio in the audio segment and text in the matching portion.

2. The method of claim 1, wherein the plurality of audio segments have a same length.

3. The method of claim 1, wherein the plurality of audio segments have different lengths.

4. The method of claim 1, wherein dividing the audio data into the plurality of audio segments comprises using a voice activity detection (VAD) method to divide the audio data.

5. The method of claim 1, wherein identifying the matching portion of the ground-truth text transcript that matches the machine transcript of the audio segment comprises:
identifying one or more characters in the ground-truth text transcript that match one or more beginning characters in the machine transcript of the audio segment;
identifying one or more characters in the ground-truth text transcript that match one or more ending characters in the machine transcript of the audio segment; and
identifying, as the matching portion of the ground-truth text transcript, a portion of the ground-truth text transcript that includes (i) the one or more characters in the ground-truth text transcript that match the one or more beginning characters of the machine transcript of the audio segment, (ii) the one or more characters in the ground-truth text transcript that match the one or more ending characters of the machine transcript of the audio segment, and (iii) any characters in between (i) and (ii) in the ground-truth text transcript.

6. The method of claim 5, wherein identifying the one or more characters in the ground-truth text transcript that match the one or more beginning characters in the machine transcript of the audio segment comprises:
identifying the one or more characters in the ground-truth text transcript based on computing an edit distance between (i) characters in the ground-truth text transcript and (ii) the one or more beginning characters in in the machine transcript of the audio segment.

7. The method of claim 5, wherein identifying the one or more characters in the ground-truth text transcript that match the one or more ending characters in the machine transcript of the audio segment comprises:
identifying the one or more characters in the ground-truth text transcript based on computing an edit distance between (i) characters in the ground-truth text transcript and (ii) the one or more ending characters in in the machine transcript of the audio segment.

8. The method of claim 7, wherein the edit distance comprises a Levenshtein distance.

9. The method of claim 1, further comprising
combining the audio-text alignment data for each of the plurality of audio segments to generate combined audio-text alignment data.

10. The method of claim 9, further comprising using the combined audio-text alignment data to generate audio-text training data for training a multimodal neural network.

11. The method of claim 9, further comprising using the combined audio-text alignment data to generate timed text for the audio data.

12. The method of claim 1, wherein the audio data comprises audio of a long audio session.

13. A system comprising:
one or more computers; and
one or more storage devices storing instructions that, when executed by the one or more computers, cause the one or more computers to perform operations comprising:
receiving audio data and a ground-truth text transcript of the audio data to be aligned with the audio data;
dividing the audio data into a plurality of audio segments;
for each of the plurality of audio segments:
processing the audio segment using an automatic speech recognition (ASR) model to generate a machine transcript of the audio segment;
identifying, from the ground-truth text transcript, a matching portion of the ground-truth text transcript that matches the machine transcript of the audio segment; and
generating audio-text alignment data that defines a correspondence between audio in the audio segment and text in the matching portion.

14. The system of claim 13, wherein the plurality of audio segments have a same length.

15. The system of claim 13, wherein the plurality of audio segments have different lengths.

16. The system of claim 13, wherein dividing the audio data into the plurality of audio segments comprises using a voice activity detection (VAD) method to divide the audio data.

17. The system of claim 13, wherein identifying the matching portion of the ground-truth text transcript that matches the machine transcript of the audio segment comprises:
identifying one or more characters in the ground-truth text transcript that match one or more beginning characters in the machine transcript of the audio segment;
identifying one or more characters in the ground-truth text transcript that match one or more ending characters in the machine transcript of the audio segment; and
identifying, as the matching portion of the ground-truth text transcript, a portion of the ground-truth text transcript that includes (i) the one or more characters in the ground-truth text transcript that match the one or more beginning characters of the machine transcript of the audio segment, (ii) the one or more characters in the ground-truth text transcript that match the one or more ending characters of the machine transcript of the audio segment, and (iii) any characters in between (i) and (ii) in the ground-truth text transcript.

18. The system of claim 17, wherein identifying the one or more characters in the ground-truth text transcript that match the one or more beginning characters in the machine transcript of the audio segment comprises:
identifying the one or more characters in the ground-truth text transcript based on computing an edit distance between (i) characters in the ground-truth text transcript and (ii) the one or more beginning characters in in the machine transcript of the audio segment.

19. The system of claim 18, wherein the edit distance comprises a Levenshtein distance.

20. One or more non-transitory computer-readable storage media storing instructions that when executed by one or more computers cause the one or more computers to perform operations comprising:
receiving audio data and a ground-truth text transcript of the audio data to be aligned with the audio data;
dividing the audio data into a plurality of audio segments;
for each of the plurality of audio segments:
processing the audio segment using an automatic speech recognition (ASR) model to generate a machine transcript of the audio segment;
identifying, from the ground-truth text transcript, a matching portion of the ground-truth text transcript that matches the machine transcript of the audio segment; and
generating audio-text alignment data that defines a correspondence between audio in the audio segment and text in the matching portion.
